(19) United States
(12) Patent Application Publication
(10) Pub. No.: US 2010/0142183 A1
(43) Pub. Date: Jun. 10, 2010

(54) LIGHT GUIDE UNIT FOR ILLUMINATING FUNCTIONAL AREAS

(75) Inventor: Jacob LERENIUS, Stockholm (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/331,646

(22) Filed: Dec. 10, 2008

(51) Int. Cl. F21V 33/00; F21V 7/00

(52) U.S. Cl. 362/85; 362/341

(57) ABSTRACT

The present invention relates to a method and a light guide for illumination of a functional area of portable communication devices. By applying a light reflecting microstructure and quantum dots in the same light guide, a number of advantages are gained, as compared to the provision of multiple light guides stacked onto each other comprising microstructures. By subjecting the singular light guide to light having either one wavelength or another wavelength, different illumination patterns can be provided for functional areas in portable communication devices, such as mobile phones. Moreover, dual illumination patterns that may be overlapping can be provided in the in one and the same colour.

### TECHNICAL FIELD

The present invention relates in general to a unit and a method for illumination of functional areas, in more particular to a light guide unit and a method for illumination of keypads or touch responsive areas in portable communication devices.

### BACKGROUND

A portable communication device, such as a mobile terminal, may provide various functionalities, such as communication, games, and multi-media rendering. For each functionality, the portable communication device may be put in a corresponding operational mode, such as a communication mode, a game mode, and/or a multi-media mode. In each mode, the user may operate the portable communication device by interacting with one or more user input units, such as for example hard keys, soft keys and joy sticks.

Moreover, the portable communication device may comprise several operational modes. In order to limit the number of user input units necessary, each user input unit may be used in connection with several functionalities, where each functionality is depending on the operational mode. For example, in the communication mode, a single key may be used for entering a “1”, whereas the same key in the multi-media mode may be used for initiating a “play” command for rendering of multi-media data.

To provide easy operation of the portable communication device, symbols are commonly provided in connection with a corresponding user input unit. The symbol relating to the functionality may be formed integrally with or formed at the user input unit. If each user input unit were associated with several functionalities, several symbols would have to be provided in connection with each user input unit.

The provisioning of a large number of symbols for each user input unit would however be a problem as the physical area available at a portable communication device is limited. For this reason, the symbols would have to be relatively small, possibly causing some to be illegible. Furthermore, it would be difficult to distinguish the symbols from each other, causing confusion for the user as the current functionality of the user input unit could be unclear.

One way of providing a symbol integrally with a user input unit is to arrange a light reflecting microstructure within a light guide, which upon illumination can reflect light and in this way provide an illumination symbol according to the layout of the light reflecting microstructure.

Attempts have been made to provide a dual alternate illumination pattern using light reflecting microstructures, by arranging two light guides on top on each other, wherein each light guide has a specific microstructure. Upon sending light into an alternating light guide, alternate illumination patterns can in principle be obtained. There are however disadvantages with such an arrangement, of which one is due the air gap between the two stacking light guide, causing light reflection, leakage of light and reduced intensity. Moreover, light leakage may illuminate the alternative microstructure causing a pattern disturbance and a reduced resolution. In addition, in the case the microstructures are overlapping, light reflected by one microstructure may also be reflected by the other microstructure, with a reduced resolution and intensity of the emitted light, as a result.

Quantum dots can be artificially fabricated and have a structure that comprise electrons and holes. Quantum dots have a photo-luminescent property to absorb light having one wavelength and re-emit light having a longer wavelength. The colour characteristics of emitted light from quantum dots is dependent on the size of the quantum dots, which typically ranges from a nanometer to a micrometer. Also, the colour characteristics typically depend on the chemical composition of the quantum dots. Quantum dots can be produced for generating light with narrow band wavelengths upon illumination. Also white light may be generated.

In US2006/0103589 A1, Chua et al. recently used quantum dots, also known as semi-conductor nanocrystals, in a wavelength shifting region of a light panel to convert originating light to converted light to provide illuminating light with a shifted colour. Such an arrangement may thus be used to provide illumination with a uniform colour.

There is still a need to provide an alternative to the illumination techniques as presently known to evade at least some of the disadvantages of prior art techniques.

### SUMMARY

The present invention is directed towards providing a dual alternate illumination pattern for functional areas of portable communication devices.

According to one aspect of the present invention, there is provided an light guide unit for illuminating a functional area of a portable communication device, the light guide unit comprising a singular light guide for emitting illuminating light, said light guide comprising, a wavelength converting material, adapted to conditionally convert light of a first wavelength to light of a second wavelength in dependence of the first wavelength, upon receipt of said light of the first wavelength and a light reflecting microstructure adapted to reflect part of the light of the first wavelength, enabling the singular light guide to provide either a first or a second illumination pattern of light in dependence of the first wavelength of the received light, upon receipt of said light of the first wavelength.

According to another aspect of the present invention, there is provided a method for providing dual alternative patterns by a singular light guide upon receipt of light by the singular light guide, comprising the steps of receiving incident light of a first wavelength by the singular light guide, reflecting part of the incident light of the first wavelength by a light reflecting microstructure within said singular light guide, conditionally exciting a wavelength converting material with at part of the received light of the first wavelength, in dependence of the first wavelength, and providing either a first or a second illumination pattern of light by the singular light guide, in dependence of the first wavelength of the received light.

One advantage of at least some embodiments of the present invention is the possibility to present overlapping patterns on touch responsive areas such as keypads and touch responsive areas.

Another advantage of at least some embodiments of the present invention is an improved visual experience of the information to be presented, since at least one of the presented patterns can be presented with a high resolution.

Another advantage of at least some embodiments of the present invention is an improved intensity of a light pattern to be presented.

Another advantage with at least some of the embodiments of the present invention is that it enables different overlapping light patterns to be presented having the same colour of the light for illumination.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments will be described below, references being made to the accompanying drawings, in which

FIGS. 1 and 2 illustrate a schematic presentation of portable communication device having a light guide unit according to some embodiments of the present invention,

FIG. 3 illustrates method steps of a method for providing dual alternative illumination patterns in a light guide unit, according to some embodiments of the present invention,

FIG. 4 illustrates a schematic representation of a first and a second pattern,

FIG. 5 illustrates a schematic representation of a second light pattern upon illumination of a light guide unit, and

FIG. 6 illustrates a schematic representation of a first light pattern, upon illumination of a light guide unit.

### DETAILED DESCRIPTION

Illumination of keypads and/or touch sensitive functional areas have become important features in portable communication devices. One reason therefore can be that the function of keypads and and/or touch sensitive functional areas should be visible in the dark.

Illumination provides hereby yet another possibility to present multiple alternative patterns at functional areas indicating the function of the user input unit. By illuminating a light guide with light of different wavelengths, different light patterns can be provided and presented to the user of a portable communication device.

With reference to the figures as presented above, a few embodiments of the present invention will now be explained.

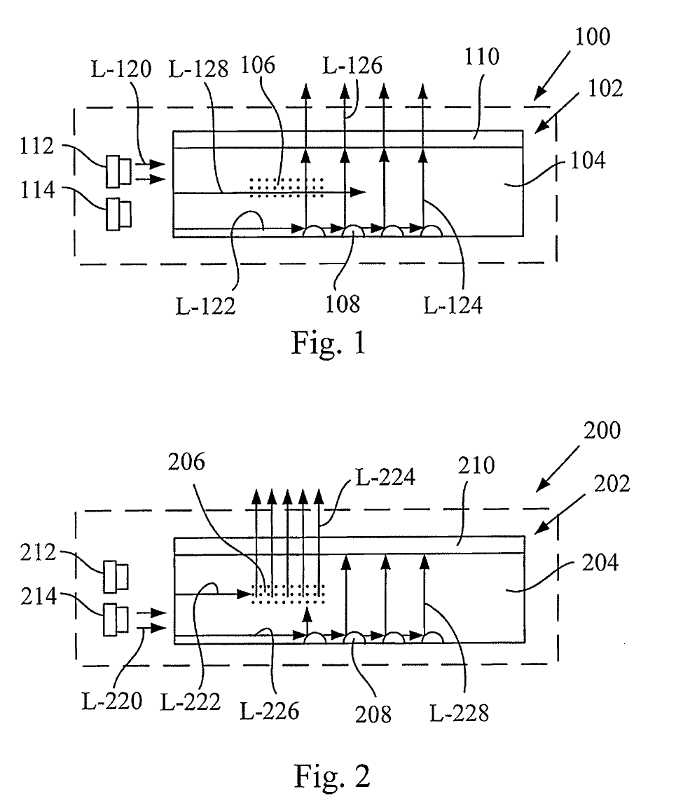

FIG. 1 presents a lateral view of a portable communication device 100, such as a mobile phone, having light guide unit 102, comprising a light guide 104 that comprises a wavelength converting material 106 and a light reflecting microstructure 108. A colour filter is denoted as 110, and may be adapted to at least partially block light having a wavelength that is shorter than the excitation wavelength of the wavelength converting material 106. Moreover, FIG. 1 also presents a first and second light source, denoted as 112 and 114, respectively. These light sources may be adapted to produce essentially monochromatic light, but may be adapted to produce light having a plurality of frequencies. The first light source 112 may be adapted to send light of a wavelength that is longer than the excitation wavelength of the wavelength converting material, whereas the second light source 114 may be adapted to send light of a wavelength that is shorter than the excitation wavelength of the wavelength converting material.

The wavelength converting material may be arranged to convert incident light of a first wavelength to emitted light of a second wavelength. This conversion is dependent on the wavelength of the incident light.

The wavelength converting material may comprise quantum dots 106, which can absorb light of a first wavelength and emit light of a second and a longer wavelength.

The light reflecting microstructure 108 as comprised in the light guide can be arranged to reflect light such that for example light can be reflected into a direction perpendicular to the direction of the incident light.

According to some embodiments of the present invention, the light reflecting microstructure 108 may be provided as a plurality of conformities having a face or part of a face making an angle of approximately 45 degrees with the direction of the incident light. As an alternative, the light reflecting microstructure may be formed by a plurality of mirrors arranged at an angle of ca 45 degree in relation to the direction of the incident light. When sending incident light into a light guide unit arranged with such a light reflecting microstructure, light can be reflected in a direction essentially normal to the direction of incident light and could then provide for example illumination of a touch responsive area, according to at least some embodiments of the present invention.

FIG. 1 also schematically illustrates simplified light paths for light having a wavelength that is longer than the excitation wavelength of the quantum dots 106, i.e. for incident light that has too a low energy to excite the quantum dots 106. As this light is not excited by the quantum dots, the quantum dots may be perceived as being transparent by said light.

Upon subjecting the light guide unit 102 to light L-120 of a wavelength λ that is longer than the excitation wavelength of the wavelength converting material, directed essentially perpendicular to a side of the light guide unit, as indicated in FIG. 1, part of the light may continue as light L-122 within the light guide 102 toward a light reflecting microstructure 108. The light L-120 of a wavelength longer than the excitation wavelength of the wavelength converting material, can for example be provided from the first light source 112, as discussed above.

The light reflecting microstructure 106 may be arranged to reflect light in a direction essentially perpendicular to the direction of the incident light, enabling an illumination pattern to be provided.

Light reflected by the light reflecting microstructure 108, that is light L-124, may then be subjected to a colour filter 110, which can be arranged to at least partly block light having a wavelength shorter than the excitation wavelength of the wavelength converting material. Since the light L-124 has a wavelength that is longer the excitation wavelength of the wavelength converting material, the light L-124 is substantially not blocked and for which reason at least part of it can penetrate the colour filter and be emitted as light L-126. This emitted light may thus provide illumination of a keypad or touch responsive areas.

By providing the light reflecting microstructure as a certain pattern, the light reflected from it may receive a pattern resembling said certain pattern. By providing a microstructure having, for instance, the form or shape of “1”, an emitted illumination pattern presenting “1” would thus be provided.

Since the wavelength converting material may be conditionally excited dependent on the wavelength of the incident light, a light path scenario can be realized for an incident light having a wavelength shorter than the excitation wavelength, as compared with the light path scenario as presented in connection with FIG. 1.

With reference to FIG. 2 the light guide unit of the portable communication device 200 is discussed while it is being subjected to light having a different wavelength as compared to the example as described in FIG. 1.

It should be mentioned that the technical features of FIG. 1 have again been presented in FIG. 2. Each technical feature from FIG. 1 as reference with the reference numeral 1XX has received the corresponding reference numeral 2XX in FIG. 2.

Thus, with reference numerals 212 and 214 a first and a second light source, respectively, are presented. The first light source 212 is adapted to provide light into the light guide unit of a wavelength that is longer than the excitation wavelength of the quantum dots. The second light source 214 is adapted to provide light into the same light guide unit of a wavelength that is shorter than the excitation wavelength of the quantum dots.

Upon subjecting quantum dots to light with energy high enough to excite the quantum dots, the quantum dots can emit light with a wavelength that is longer than the one of the incident light. The wavelength of the emitted light is moreover dependent on the size of the quantum dots and the chemical composition of the dots. The smaller the dots, the shorter the wavelength of the emitted light, upon excitation. Common features of quantum dots are well known to a skilled person in the art and will hence not be discussed further herein.

In FIG. 2, the second light source 214 thus provides light into the light guide unit 202 of a wavelength that is shorter than the excitation wavelength of the quantum dots 206. Thus, upon subjecting the light guide unit 202 of the portable communication device 200 to incident light L-220 of a wavelength λ that is shorter than the excitation wavelength for the quantum dots, at least part of the incident light is propagated as light L-222 and directed towards the quantum dots. This light L-222 has hence the same wavelength as the incident light L-220, i.e. a wavelength that is shorter than the excitation wavelength of the quantum dots.

This means that the energy of the light L-222 is high enough to excite the quantum dots, since light having a shorter wavelength than the excitation wavelength excites said quantum dots 206 when being subjected to the quantum dots.

The quantum dots, being one example of a wavelength converting material has the capability to convert the wavelength of light subjected to the material to a longer wavelength, for which reason light emitted from the wavelength material is of a longer wavelength than the light subjected to the wavelength converting material, as long as the incident light can excite the quantum dots.

Thus, the light L-222 excites the quantum dots, with the effect that light with a lower energy is emitted from the quantum dots as light L-224. This light is then passed through the colour filter 210. As the colour filter may be adapted to at least partially block light having a wavelength shorter than the excitation wavelength of the quantum dots, light L-224 is passed through the filter 210 without being significantly affected by the colour filter 210.

Thus, upon subjecting the light guide unit 202 with light having a wavelength that is shorter that the excitation wavelength of the quantum dots 206, light L-224 of a longer wavelength may be emitted in a direction perpendicular to the direction of the incident light, L-220.

Also, when subjecting the light guide unit 202 to incident light L-220, not only the wavelength converting material 206 is subjected to light. In addition, the light reflecting microstructure 208 is also subjected to the incident light L-220.

Part of the incident light L-220 having a wavelength shorter than the excitation wavelength of the quantum dots, may reach the light reflecting microstructure 208.

Part of light L-220 to which the light guide unit is subjected may hence reach the light reflecting microstructure 208 as light L-226, having the same wavelength as the light L-220. The light reflecting microstructure may reflect light into a direction approximately perpendicular to the direction of the incident light L-226. The reflected light L-228 may thus be directed to the colour filer 210, as presented in FIG. 2. The colour filter 210, that is adapted to at least partially block light of a wavelength shorter than the excitation wavelength, therefore at least partially blocks light L-228 from passing through said colour filter L-228.

As an effect, when on the one hand subjecting the light guide unit 202 to light having a wavelength shorter than the excitation wavelength of the quantum dots, by using for instance the second light source 214, light emitted from the light guide unit 202 may be in the form of light L-224 having a wavelength longer than wavelength of the incident light L-220 exciting the quantum dots.

When on the other hand, as described above, subjecting the light guide unit to light having a wavelength longer than the wavelength of excitation of the quantum dots, part of the incident light will be reflected by the light reflecting microstructure 108 and be emitted with a wavelength that is the same as the incident light L-120, in the form of light L-126.

By subjecting the light guide unit to light of different wavelengths, different user experiences are thus provided.

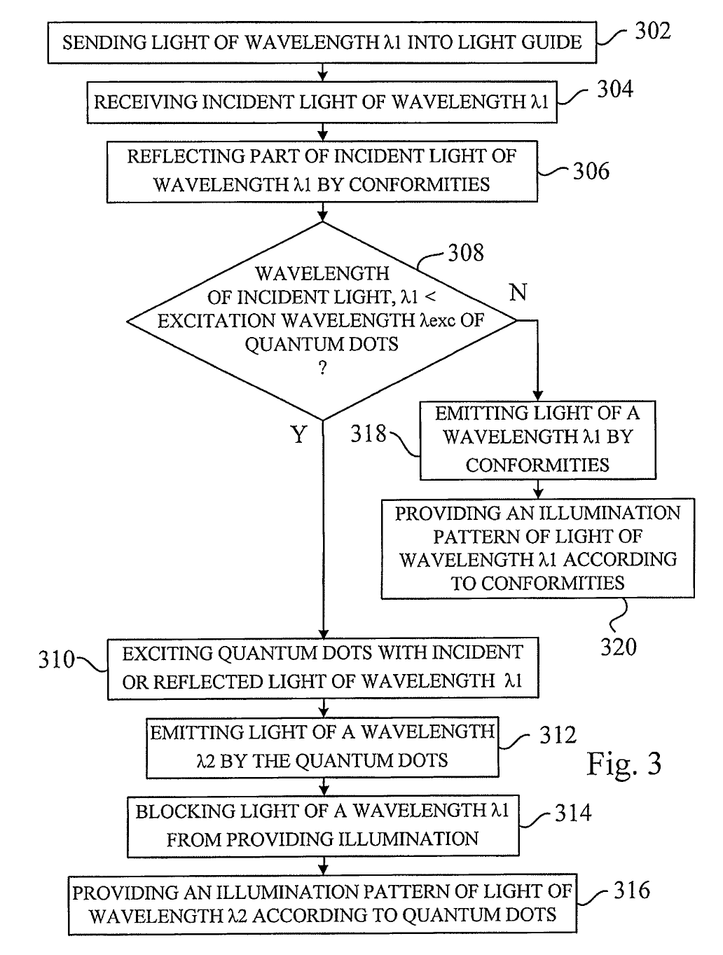

With reference to FIG. 3 method steps of a method for providing dual illumination patterns will now be described.

The method may start by step 302, sending light of wavelength λ1 into the light guide 104, 204 of the light guide unit 102, 202. This light may be sent by either the first light source 112, 212 or the second light source 114, 214.

Step 302 is to provide light that can be subjected to the light guide unit 102, 202.

The light sent in step 302 is received as incident light of wavelength λ1 in step 304. This light may comprise light L-126 and light L-122, as illustrated in FIG. 1. Alternatively, the light as received by the light guide may comprise light L-222 and light L-226, as illustrated in FIG. 2.

Having received light, part of the incident light of wavelength λ1 may now be reflected by conformities, such as a light reflecting microstructure, step 306.

This microstructure is thus comprised within the light guide and may be formed as hemispherical indentations, as triangularly shaped indentations, or may be provided in any other form or shape, where as least part of the microstructure has a face towards which light can be redirected approximately 90 degrees.

Part of the incident light can thus be reflected by the light reflecting microstructure 108, 208 in step 306.

If the wavelength of the incident light, λ1 is shorter than the excitation wavelength λexc of the quantum dots, as queried in step 308, the following step is the step of exciting the quantum dots with incident light L-222 or possibly with reflected light of a wavelength λ1.

The quantum dots are thus excited by the light having energy high enough to excite the quantum dots.

After the excitation of the quantum dots, the quantum dots can emit light of a wavelength λ2 that is longer than λ1, in step 312.

Upon excitation of the quantum dots with light of a wavelength λ1, light can be emitted from the quantum dots of a wavelength λ2, where λ1<λ2. The energy of the emitted light may thus be lower than the energy of the received light, L-222.

A further step in the method may be the step 314, blocking light of a wavelength λ1 from providing illumination, which step is performed by the colour filter 210, wherein light of a wavelength λ1 is at least partially blocked from passing the colour filter 210.

As the colour filter at least partially blocks light having a wavelength that is shorter than the excitation wavelength λexc, the light emitted from the light guide unit may be comprised of light L-224, when subjecting the light guide to light that causes the quantum dots to be excited.

The user impression of emitted light can moreover be affected by the macroscopic overall shape or distribution of the quantum dots as provided in the light guide. If forming the quantum dots according to a pattern, then the light emitted from the excited quantum dots will have the shape of the distributed pattern.

It should be emphasized and clarified that the quantum dots can be provided in the light guide at a very high resolution, possibly forming a number of patterns requiring a high resolution. One example is to form the logotype of the company Sony Ericsson in the light guide, which would upon receiving a light having a wavelength shorter than the excitation wavelength of the quantum dots, and form an emitted light having the same of similar form as the quantum dot pattern. It can be mentioned that two or more kinds of quantum dots may be used to provide two or more colours in the emitted light, enabling provisioning of a logotype in a plurality of colours.

Also the quantum dots are inherently very energy efficient in terms of their ability to emit light upon excitation. A relatively high intensity of the emitted light L-224 can therefore be obtained upon excitation with light L-222 having a wavelength that causes the quantum dots to be excited.

In step 316 of the method as illustrated in FIG. 3, an illumination pattern of light of wavelength λ is thus provided according to the distribution of the quantum dots in a plane in the light guide, in step 316.

FIG. 3 thus illustrates method steps for providing an illumination pattern according to the distribution of quantum dots in a light guide.

In addition, FIG. 3 also provides alternative method steps for providing a different illumination pattern to a user of a device comprising a light guide unit, according to some embodiments of the present invention

This alternative illumination pattern may be provided in the following way. If the wavelength of incident light λ1 is not shorter than the excitation wavelength λexc of the quantum dots, as queried in step 308, the quantum dots will on the one hand not be excited by light L-128. Rather the quantum dots will be perceived as being transparent to the light L-128.

On the other hand the light that is reflected by the light reflecting microstructure 108 in step 306 is emitted by the light guide in step 318, emitting light of a wavelength λ1 by conformities, such as the light reflecting microstructure.

Since the reflected light has a wavelength that is longer than the excitation wavelength of the quantum dots 106, the colour filter does not block the light L-124 and allows light L-124 to be emitted from the light guide unit 102 as light L-126.

Moreover, the distribution of the light reflecting microstructure 108, 208 in the light guide affects the emitted light by the microstructure. By providing the microstructure according to a pattern such as a plus sign “+” or a minus sign “−”, the reflected light be provided in a shape according to said signs. The distribution of the microstructures in the light guide will thus be forwarded in the emitted light.

In step 320, an illumination pattern of light of wavelength λ1 is thus provided according to the conformities in the light reflecting microstructure 108.

It is described a method to provide dual alternative illumination patterns by providing incident light of two different wavelengths into a singular light guide unit, comprising a singular light guide.

One advantage of using a singular light guide for the provision of a dual illumination pattern is the limited space requirement, when using one single light guide. The space required for one single light guide might not be compared to the space required for two or more light guides. The available space in portable communication devices, such as mobile phones, is often extremely limited, for which reason a two light guide attempt can be problematic.

In addition, if applying multiple light guides stacked onto each other, an air gap between the two light guides may cause light to disseminate with a decrease in resolution and a low light efficiency as possible results.

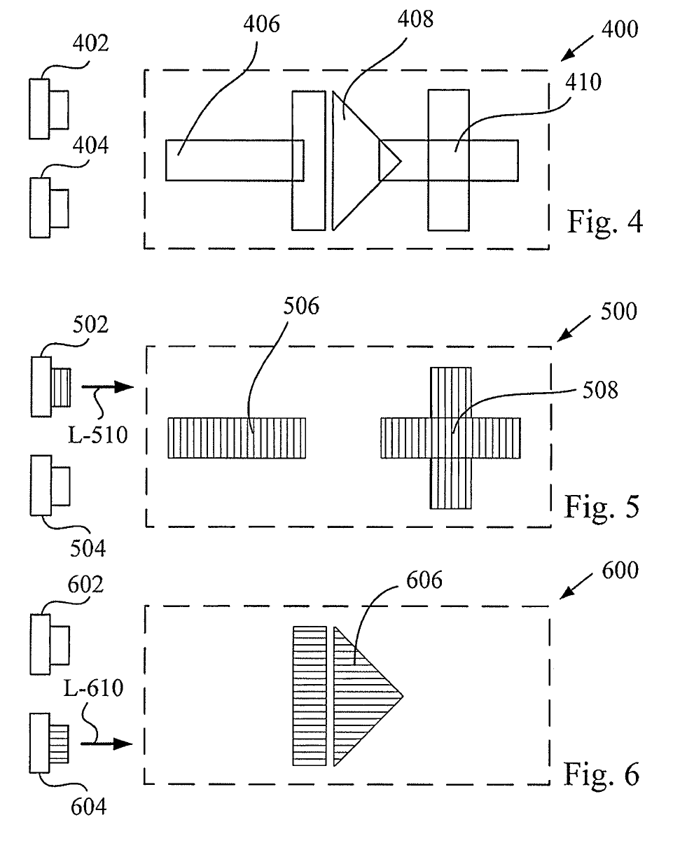

In the following, reference will be made to FIGS. 4, 5 and 6, illustrating illumination patterns of a functional area, of for instance a portable communication device.

FIG. 4 illustrates a light guide unit 400 and accompanying light sources 402 and 404. Each one of these light sources may be adapted to send light of a certain wavelength to the light guide unit 400. One light source 402 may be adapted to send light of a wavelength that is longer than the excitation wavelength of the quantum dots into the light guide unit, where another light source 404 may be adapted to send light of a wavelength that is shorter than the excitation wavelength of the quantum dots into the light guide unit.

Alternatively, light of two different wavelengths may be sent using the same light source, being adapted to send light having two alternate wavelengths.

Layout piece 406 comprises the macroscopic distribution of conformities in the light reflecting microstructure, or in other words a two-dimensional layout shape of the light reflecting microstructure. Layout pieces 408 comprise the play-pause sign, and are in this example a distribution of a wavelength converting material, and in particular the distribution of quantum dots. The layout piece 410 forming a plus sign “+”, again comprises the shape of the light reflecting microstructure.

Continuing to FIG. 5 it is illustrated the effect when subjecting a light guide unit to light having a wavelength that is longer than the excitation wavelength of the quantum dots as comprised in the light guide.

When subjecting the light guide unit to light from one light source 502 as indicated with vertical lines in FIG. 5, which light source can be adapted to send light having an energy lower than the energy required to excite the quantum dots, part of light that is sent may be reflected by a light reflecting microstructure into light corresponding to light L-124, as illustrated in FIG. 1.

For clarity and completeness it shall be mentioned that the light source 504 does not emit light in this example.

As the energy of the incident light is not sufficient to excite the quantum dots, the colour filter will allow passage of this light without substantially blocking said light. Light will thus be emitted in the form of L-126. Since the light reflecting microstructure has the shape of a “minus” sign, the reflected light will also have the shape of a minus sign, provisioning an illumination pattern 506 showing a minus sign, which is indicated with vertical lines in FIG. 5.

It is noted that the play-pause shape is not visible in the illumination pattern in the area of illumination.

Similar to the illumination pattern of area 506 being visible in FIG. 5, the illumination pattern of area 508, presenting a plus sign may also visible, for the same reason as illumination pattern 506. Vertical lines in FIG. 5 indicate the illumination pattern 508. Light is thus reflected by a light reflecting microstructure of a plus shape, for which reason light with the same wavelength as the incident light, denoted as L-122 in FIG. 1, will be emitted as L-126 in FIG. 1, and hence provide illumination of one or more specific patterns.

If however, the light guide unit is subjected to light of a wavelength that is shorter than the excitation wavelength of the quantum dots, light will be subjected to different passages in the light guide unit with the effect that an illumination pattern may be provided according to a pattern of quantum dots as provided in the singular light guide, which shape or distribution may be different from the distribution of the light reflecting microstructures, and for this reason provide a different illumination pattern.

When subjecting the light guide unit 600 to light having a wavelength that is shorter than the excitation wavelength for the quantum dots, the first light source 602 may not be used, since this light source may be adapted to emit light having a lower energy.

Hence, the second light source 604, which is indicated by horizontal lines, can be used to subject the light guide unit to light having an energy sufficient to excite the quantum dots. Upon subjecting the light guide unit to this light, light L-222, the quantum dots are excited and emit light with a longer wavelength L-224. Since the wavelength of this light is longer than the excitation wavelength of the quantum dots, the emitted light L-224 is passed through colour filter 210 without being substantially blocked. An illumination pattern in the form of a “play-pause” sign of light 606 may thus be obtained. Horizontal lines in FIG. 6 indicate the illumination pattern 606.

Part of the incident light, L-226 is reflected by the light reflecting microstructure 208, but as this reflected light has a too high an energy, it is at least partially blocked by the colour filter 210 from passing through the filter.

The effect of the passage of light L-224 and the blockade of light L-228 is the provisioning of an illumination pattern according to the shape of distribution of the quantum dots in the singular light guide unit.

Quantum dots are typically excited by light having a wavelength equal to or shorter than the excitation wavelength, λexc of the quantum dots. Moreover, quantum dots can for instance be adapted to be excited by light having a wavelength equal to or shorter than the wavelength for green light, i.e. equal to or shorter than approximately 540 nm. Quantum dots may be excited by light having even longer wavelengths also. In any case, by subjecting quantum dots for light blue, near UV or UV light by for instance using a Light Emitting Diode (LED), light of a specific colour having a respective longer wavelength can be obtained. According to the kind or type of quantum dots, the quantum dots may emit light having one of a large variety of colours. Quantum dots may accordingly emit light having a purple, indigo, blue, green, yellow, orange, or red light. Certain quantum dots may even emit white light upon excitation.

The light L-220 to which the light guide unit is subjected in order to excite the quantum dots may therefore have a wavelength shorter than 540 nm. By adapting the size and the chemical composition of the quantum dots, light throughout the visible range of ca. 390 nm to 770 nm can be obtained as emitted light.

The wavelength of the light emitted by quantum dots is dependent on the size of the quantum dots, as mentioned throughout this specification. The smaller the quantum dots, the shorter the wavelength and the bluer the emitted light becomes.

It should be noted that light reflecting microstructures can be used to reflect light in the entire range of visible light, approximately between 390 and 770 nm.

Returning to the description while referring to the accompanying figures, the light sources as illustrated in FIGS. 4, 5 and 6 may be adapted for enabling that the light emitted by the quantum dots has the same or similar wavelength as the user experienced light reflected by the light reflecting microstructure. Each one of the first 502 and second light source 604 together with the character of the quantum dots as well as the colour filter need to be selected carefully. The prerequisites are that the size of the quantum dot shall be chosen to such that the quantum dots emit a light colour with which the illumination patterns shall be lit. This light may be “redder than green”, but is however not a requirement.

It can be mentioned that the first light source 502 is indicated by vertical lines in FIG. 5, whereas the second light source is indicated by horizontal lines in FIG. 6.

Having chosen quantum dots with a desired colour of the emitted light, the colour filter 110, 210 is chosen such that it substantially blocks the light colour with which the quantum dots is chosen to be excited. The second light source 604 is then simply chosen to be able to send light of a wavelength that is shorter than the excitation wavelength of the quantum dots. In addition, the first light source 502 is chosen to emit light with the same as the desired colour of the illumination patterns.

For example, pone that the desired colour of the illumination patterns is red. Then the quantum dots would be chosen such that the emitted light from the quantum dots is red, upon excitation. The second light source is chosen to emit a wavelength that excites the quantum dots, which wavelength could for instance be blue. The colour filter is then chosen to substantially block light that is “bluer” than red. Moreover, the second light source is chosen to emit blue light and the first light source is chosen to emit red light.

By making these choices and subjecting a light guide unit according to at least some embodiments of the present invention, dual alternate illumination patterns can be provided in the same or similar colour, wherein alternate illumination patterns may very well overlap with each other.

In addition, illumination patterns of light having more colours may also be provided. For instance, an illumination pattern having green and yellow light may be provided. Another example is to provide a yellow and red illumination pattern. Such illumination patterns may be provided by arranging at least two kinds or types of quantum dots in the light guide, and exciting both kinds or types of quantum dots by using light of one of more wavelengths, upon which light can be emitted by the quantum dots at different wavelengths according to their respective kind or type. The quantum dots that can emit yellow light and the quantum dots that can emit red light, can thus be subjected to the same light provided that this light has a wavelength that is shorter than the excitation wavelength of both kinds or types of quantum dots.

At least some of the embodiments come with a number of advantages of which a few are:

The usage of a singular light guide for the provision of a dual illumination pattern limits the required space of an illuminated display.

Another advantage of using one singular light guide is the high resolution and high-energy efficiency as obtained when applying quantum dots in the light guide, as compared to the usage of reflecting microstructures only.

Yet another advantage with a single light guide is that the drawback of having two light guides where each has a microstructure. When stacking the light guides the illumination patterns may be experienced as being provided at different depths in the display. A reduction in the depth difference of microstructure patterns however negatively affects the energy efficiency of the light guide since less light is received in a thinner light guide.

Still yet another advantage of using a single light guide is that air gap problems between stacking light guides are circumvented, as mentioned above.

Also, the space required for one single light guide might not be compared to the space required for two or more light guides. The available space in portable communication devices, such as mobile phones, is often extremely limited, for which reason a two light guide attempt can be problematic.

Still yet another advantage of using a single light guide is that air gap problems between stacking light guides are circumvented. When applying multiple light guides stacked onto each other, an air gap between the two light guides may cause light to disseminate with a decrease in resolution and a low light efficiency as possible results.

Yet another advantage of using quantum dots is the resolution of the dots and the ease with which quantum dot structures can be applied to a light guide layer. Printing techniques may be used to apply quantum dots on a specific light guide layer.

Additional user experiences of the provision of dual alternate illumination patterns can for instance be obtained. For instance, when designing the patterns linked to each other, could give the impression of an animated pattern such as a turning wheel, when alternating provide one illumination pattern and alternating the other illumination pattern.

It is emphasized that the present invention can be varied in many ways, of which the embodiments as presented are just a few examples. These embodiments are hence non-limiting. The scope of the present invention is however, limited by the subsequently following claims.

1. A light guide unit for illuminating a functional area of a portable communication device, the light guide unit comprising:
a singular light guide for emitting illuminating light, said light guide comprising,
a wavelength converting material, adapted to conditionally convert light of a first wavelength to light of a second wavelength in dependence of the first wavelength, upon receipt of said light of the first wavelength and
a light reflecting microstructure adapted to reflect part of the light of the first wavelength,
enabling the singular light guide to provide either a first or a second illumination pattern of light in dependence of the first wavelength of the received light, upon receipt of said light of the first wavelength.

2. The light guide unit according to claim 1, wherein the wavelength converting material is adapted to be excited upon receipt of light of the first wavelength, in case of the first wavelength of said light being shorter than the wavelength of excitation of the wavelength converting material.

3. The light guide unit according to claim 1, wherein the wavelength converting material is adapted to emit light of a second wavelength, in case of the first wavelength being shorter than the wavelength of excitation of the wavelength converting material.

4. The light guide unit according to claim 1, wherein the wavelength converting material comprises quantum dots adapted to emit light of a second wavelength upon excitation of said quantum dots.

5. The light guide unit according to claim 1, further comprising a light filtering means arranged in optical contact with the light guide, wherein the light filtering means is adapted to at least partly block illuminating light of a wavelength shorter than the wavelength of excitation of the wavelength converting material.

6. The light guide unit according to claim 1, wherein the wavelength converting material is distributed in the light guide according to the first illumination pattern.

7. The light guide unit according to claim 1, wherein the light reflecting microstructure is arranged in the light guide according to the second illumination pattern.

8. The light guide unit according to claim 1, wherein the light guide unit is comprised in a portable communication device.

9. The light guide unit according to claim 8, wherein the portable communication device is a mobile phone.

10. A portable communication device comprising a light guide unit according to claim 1, further comprising at least one light source adapted to subject the light guide to light of at least a first wavelength.

11. A method for providing dual alternative patterns by a singular light guide upon receipt of light by the singular light guide, comprising the steps of:
receiving incident light of a first wavelength by the singular light guide,
Reflecting part of the incident light of the first wavelength by a light reflecting microstructure within said singular light guide,
conditionally exciting a wavelength converting material with at part of the received light of the first wavelength, in dependence of the first wavelength, and
providing either a first or a second illumination pattern of light by the singular light guide, in dependence of the first wavelength of the received light.

12. The method according to claim 11, wherein the step of conditionally exciting further comprises exciting the wavelength converting material in case of the first wavelength of the incident light being shorter than the wavelength of excitation of the wavelength converting material.

13. The method according to claim 11, further comprising emitting light of a second wavelength by the singular light guide, in case of the first wavelength being shorter than the wavelength of excitation of the wavelength converting material.

14. The method according to claim 12, further comprising at least partly blocking light of the first wavelength from providing illumination.

15. The method according to claim 12, wherein the step of providing either a first or a second illumination pattern, comprises providing the first illumination pattern with emitted light of the second wavelength, according to the distribution of the wavelength converting material in the singular light guide.

16. The method according to claim 11, wherein the step of providing either a first or a second illumination pattern, comprises providing the second illumination pattern with emitted light of the first wavelength, according to the arrangement of the light reflecting structures within said singular light guide.

17. The method according to claim 11, wherein the first and second illumination patterns in the singular light guide at least partly overlap.

18. The method according to claim 11, wherein the step of conditionally exciting wavelength-converting material, comprises conditionally exciting quantum dots.
